(19) United States
(12) Patent Application Publication
(10) Pub. No.: US 2012/0268537 A1
(43) Pub. Date: Oct. 25, 2012

(54) PRINTING APPARATUS, PRINTING METHOD AND PROGRAM

(75) Inventors: Toru TAKAHASHI, Azumino-shi (JP); Takamitsu KONDO, Shiojiri-shi (JP); Kazuyoshi TANASE, Matsumoto-shi (JP); Hiroshi WADA, Azumino-shi (JP)

(73) Assignee: SEIKO EPSON CORPORATION, Tokyo (JP)

(21) Appl. No.: 13/452,583

(22) Filed: Apr. 20, 2012

(30) Foreign Application Priority Data
Apr. 20, 2011 (JP) 2011-094328

(51) Int. Cl. B41J 2/01

(52) U.S. Cl. 347/102

(57) ABSTRACT

A printing apparatus includes a chromatic ink ejecting nozzle that ejects a chromatic photocuring ink which is cured upon irradiation of light onto a medium, an achromatic ink ejecting nozzle that ejects an achromatic photocuring ink which is cured upon irradiation of light onto the medium, and an irradiation section that irradiates the light onto the chromatic photocuring ink impacted on the medium. At a time of applying the chromatic photocuring ink to print an image on the medium, the printing apparatus performs a process of ejecting the chromatic photocuring ink on the medium, a process of ejecting the achromatic photocuring ink on the medium from the achromatic ink ejecting nozzle in such a way as to apply the achromatic photocuring ink along an edge of an application range of the chromatic photocuring ink, and a process of irradiate the light from the irradiation section to cure the photocuring ink.

### BACKGROUND

1. Technical Field

The present invention relates to a printing apparatus, a printing method, and a program.

2. Related Art

There is a printing apparatus that ejects photocuring ink (such as ultraviolet (UV) ink) which is cured by irradiation of light (e.g., UV light or visible light). Such a printing apparatus ejects UV ink on a medium from nozzles, and then irradiates light onto dots formed on the medium. As a result, the dots are cured to be fixed on the medium (see, for example, JP-A-2000-158793).

Because photocuring ink does not easily permeate into a medium, printing an image using the photocuring ink forms dots making the printed image in a more embossed form as compared to printing an image using, for example, permeable ink (such as water-based ink).

The present inventor found a phenomenon that when an image is printed by an ink jet method using photocuring ink, the vicinity of edges of the printed image are embossed more than other portions (embossing phenomenon). The inventor also found that when a printed image is seen with light directly reflected only at a part of the printed image due to the embossing phenomenon, the printed image looks three-dimensionally, so that the printed image may be perceived thicker than the actual thickness, thereby degrading the quality of the printed image.

### SUMMARY

An advantage of some aspects of the invention is to improve the quality of an image to be printed by an ink jet method using photocuring ink.

To bring about the advantage, according to an aspect of the invention, there is provided a printing apparatus including a chromatic ink ejecting nozzle that ejects a chromatic photocuring ink which is cured upon irradiation of light onto a medium, an achromatic ink ejecting nozzle that ejects an achromatic photocuring ink which is cured upon irradiation of light onto the medium, and an irradiation section that irradiates the light onto the chromatic photocuring ink impacted on the medium, wherein at a time of applying the chromatic photocuring ink to print an image on the medium, the printing apparatus performs a process of ejecting the chromatic photocuring ink on the medium, a process of ejecting the achromatic photocuring ink on the medium from the achromatic ink ejecting nozzle in such a way as to apply the achromatic photocuring ink along an edge of an application range of the chromatic photocuring ink, and a process of irradiate the light from the irradiation section to cure the photocuring ink.

### BRIEF DESCRIPTION OF THE DRAWINGS

The invention will be described with reference to the accompanying drawings, wherein like numbers reference like elements.

FIG. 1A is an explanatory diagram of a printed image when an image is printed on a medium using UV ink.

FIG. 1B is a graph of measured value of the thickness of a region (near an edge) indicated by a dotted line in FIG. 1A.

FIG. 2A is a diagram viewing the printed image in FIG. 1A from above.

FIG. 2B is an explanatory diagram showing directly reflection of light at a part of the printed image in FIG. 2A.

FIG. 3A is an explanatory diagram of the outline of an embodiment showing how it appears when achromatic UV ink is applied with a reduced amount of ink per unit area.

FIG. 3B is an explanatory diagram of the outline of the embodiment showing how it appears when clear dots are formed along an edge on a printed image.

FIG. 4 is a block diagram of the general configuration of a printer.

FIG. 5 is an explanatory diagram of the general configuration of the printer.

FIG. 6 is an explanatory diagram of the functions of a printer driver of a computer.

FIG. 7 is a flowchart of a clear image generating process in FIG. 6.

FIG. 8A is an explanatory diagram of image data in black after a half-tone process in FIG. 6.

FIG. 8B is an explanatory diagram of edge pixels.

FIG. 9A is an explanatory diagram of image data for clear ink of 256 gradations.

FIG. 9B is an explanatory diagram of image data for clear ink of two gradations.

FIG. 10A is an explanatory diagram when the positional relation between the application range of a printed image and the application range image of clear ink is deviated.

FIG. 10B is an explanatory diagram of another embodiment showing clear dots formed on a printed image along an edge thereof.

### DESCRIPTION OF EXEMPLARY EMBODIMENTS

At least the following becomes apparent from the description herein and the illustration of the accompanying drawings.

There is provided a printing apparatus including a chromatic ink ejecting nozzle that ejects a chromatic photocuring ink which is cured upon irradiation of light onto a medium, an achromatic ink ejecting nozzle that ejects an achromatic photocuring ink which is cured upon irradiation of light onto the medium, and an irradiation section that irradiates the light onto the chromatic photocuring ink impacted on the medium, wherein at a time of applying the chromatic photocuring ink to print an image on the medium, the printing apparatus performs a process of ejecting the chromatic photocuring ink on the medium, a process of ejecting the achromatic photocuring ink on the medium from the achromatic ink ejecting nozzle in such a way as to apply the achromatic photocuring ink along an edge of an application range of the chromatic photocuring ink, and a process of irradiate the light from the irradiation section to cure the photocuring ink.

This printing apparatus can improve the quality of an image to be printed by an ink jet method using photocuring ink.

It is desirable that the amount of ink per unit area in the application range of the achromatic photocuring ink should be less than the amount of ink per unit area in the application range of the chromatic photocuring ink. This makes it possible to form irregularities on the surface to suppress embossing feeling.

It is desirable that a dot size of the achromatic photocuring ink should be less than a dot interval of the achromatic photocuring ink. This makes it possible to efficiently form irregularities with a smaller amount of ink.

It is desirable that the achromatic photocuring ink should be applied to outside the application range of the chromatic photocuring ink. Accordingly, even when the positional relation between the application range of chromatic photocuring ink and the application range of achromatic photocuring ink is deviated, embossing feeling can be suppressed.

It is desirable that the image should be printed on a medium which does not have an ink absorbing layer. This printing apparatus is particularly effective when printing an image on a medium which does not have ink absorption by an ink jet method using photocuring ink.

There is provided a printing method using a chromatic ink ejecting nozzle that ejects a chromatic photocuring ink which is cured upon irradiation of light onto a medium, an achromatic ink ejecting nozzle that ejects an achromatic photocuring ink which is cured upon irradiation of light onto the medium, and an irradiation section that irradiates the light onto the chromatic photocuring ink impacted on the medium, wherein at a time of applying the chromatic photocuring ink to print an image on the medium, the printing method performs a process of ejecting the chromatic photocuring ink on the medium, a process of ejecting the achromatic photocuring ink on the medium from the achromatic ink ejecting nozzle in such a way as to apply the achromatic photocuring ink along an edge of an application range of the chromatic photocuring ink, and a process of irradiate the light from the irradiation section to cure the photocuring ink.

This printing method can improve the quality of an image to be printed by an ink jet method using photocuring ink.

There is provided a program allowing a printing apparatus including a chromatic ink ejecting nozzle that ejects a chromatic photocuring ink which is cured upon irradiation of light onto a medium, an achromatic ink ejecting nozzle that ejects an achromatic photocuring ink which is cured upon irradiation of light onto the medium, and an irradiation section that irradiates the light onto the chromatic photocuring ink impacted on the medium to perform, at a time of applying the chromatic photocuring ink to print an image on the medium, a process of ejecting the chromatic photocuring ink on the medium, a process of ejecting the achromatic photocuring ink on the medium from the achromatic ink ejecting nozzle in such a way as to apply the achromatic photocuring ink along an edge of an application range of the chromatic photocuring ink, and a process of irradiate the light from the irradiation section to cure the photocuring ink.

This program can improve the quality of an image to be printed by an ink jet method using photocuring ink.

### Outline

### Embossing Phenomenon and Embossing Feeling

Because a medium such as a plastic film has a property of not easily absorbing ink, UV ink may be used as photocuring ink in printing on such a medium by an ink jet method. UV ink has a property of being cured with irradiation of UV light. Curing UV ink to form dots can permit printing to be done on a non-ink-absorbent medium which does not have an ink absorbing layer.

It is to be noted that dots formed with UV ink are embossed on the surface of the medium, so that when a printed image is formed on the medium using the UV ink, irregularities can be formed on the surface of the medium. When the printed image is a filled image or so, the printed image becomes thick.

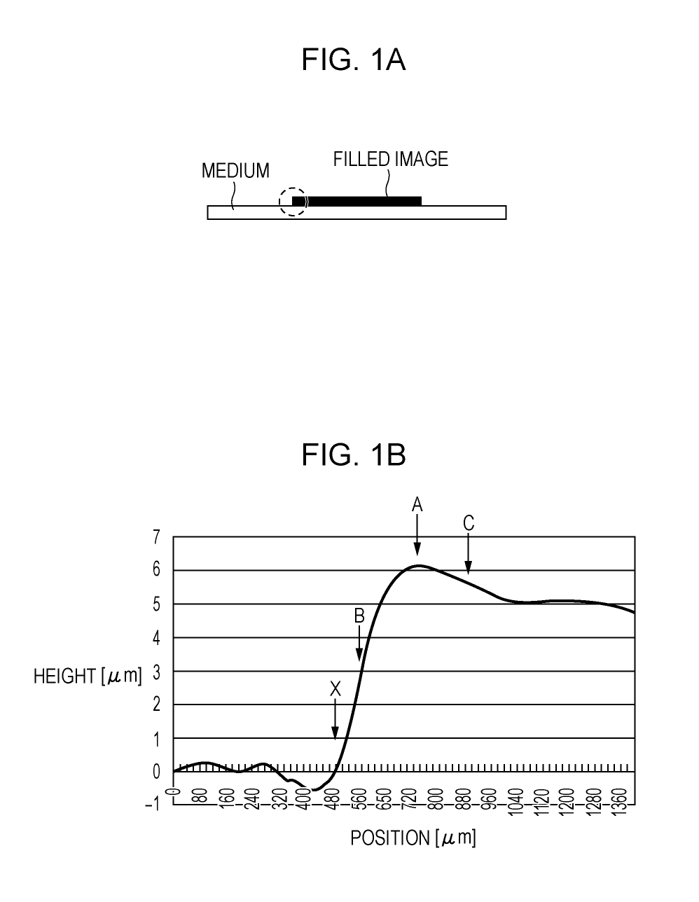

FIG. 1A is an explanatory diagram of a printed image when an image is printed on a medium using UV ink.

UV ink does not easily permeate into a medium, so that when an image is printed on the medium using the UV ink, dots are formed embossed. When an image to be filled (filled image) is printed, dots formed with the UV ink fill in a predetermined region, so that a thick printed image is formed on the medium. When characters are to be printed on the medium, for example, a thick character image (an example of a filled image) is formed on the medium. The printed image printed using the UV ink has a thickness of several μm or so.

FIG. 1B is a graph of measured value of the thickness of a region (near an edge) indicated by a dotted line in FIG. 1A. The abscissa of the graph represents the position on a medium, and the ordinate represents the height of dots (thickness of the printed image). The printed image is an image having dots formed with an ink weight of 10 ng and filled at a printing resolution of 720×720 dpi. The thickness of the printed image was measured using Quick Vision Streamplus, a Mitutoyo Non-stop CNC image measuring instrument. As illustrated in FIG. 1B, this printed image has a thickness of 5 μm or so.

A position X in the graph indicates the outermost position of the printed image. In other words, the position X indicates the position of an edge (contour) of the printed image. A position A in the graph indicates the thickest position (highest position) near the edge of the printed image. In other words, the position A indicates the position of a protruding portion near the edge of the printed image.

The position A lies inward of the position X by about 200 μm. Between the position X and the position A (region B in the graph), the more inward a position in the printed image is, the thicker the printed image becomes gradually. Although the vertical and horizontal scales do not match with each other in the graph, the printed image is actually inclined by an angle of less than 3° in the region B in the graph. In a region inward of the position A in the printed image (region C in the graph), the more inward a position in the printed image is, the thinner the printed image becomes gradually, and the thickness becomes substantially uniform when the thickness reaches 5 μm or so.

A phenomenon that the vicinity of an edge is particularly embossed more than other portions as in the position A in the graph is called “embossing phenomenon” herein. This embossing phenomenon uniquely occurs when an image is printed by an ink jet method using UV ink.

Although a mechanism of causing the embossing phenomenon is not clear, the embossing phenomenon seems to occur approximately as follows. Although UV ink has a higher viscosity than permeable ink, it has a fluidity enough to be ejected from nozzles by the ink jet method (the necessity of the fluidity enough for ejection from nozzles is a unique property different from ink used in prepressing). The UV ink has a fluidity even after impacted on a medium until the UV ink is irradiated with UV light to be completely cured. It seems that the embossing phenomenon occurs near an edge of a printed image due to the influence of the fluidity after the impact.

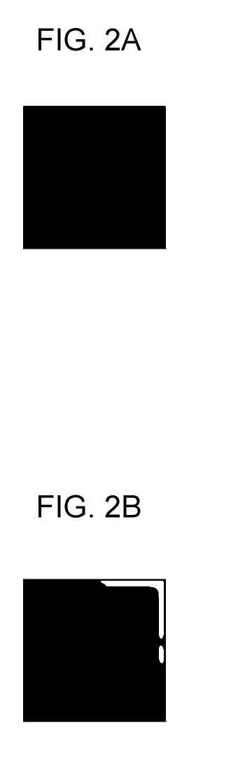

FIG. 2A is a diagram viewing the printed image in FIG. 1A from above. FIG. 2B is an explanatory diagram showing directly reflection of light at a part of the printed image in FIG. 2A. A portion which is seen bright in the printed image is shown white in FIG. 2B.

Because the thickness is substantially uniform in the center portion of the printed image, uniform glossiness is obtained. It is to be noted however that because the thickness is not uniform near the edge of the printed image, uniform glossiness is not obtained.

The printed image does not have a uniform thickness near the edge due to the embossing phenomenon, projecting portions are formed along the edge (contour) of the printed image inward of the edge thereof. As a result, a part of the printed image may be seen bright along the edge as shown in FIG. 2B depending on the angle of reflection of light. Depending on an eye of an observer, the positional relation between the light source and printed image, and the angles thereof, light directly reflected at the inclined region in FIG. 1B enters the eye of the observer so that the printed image is seen as shown in FIG. 2B.

When a part of the printed image is seen bright along the edge as shown in FIG. 2B, the entire printed image is sensed three-dimensionally. In other words, the printed image is sensed three-dimensionally as in a case where a three-dimensional object is displayed as a two-dimensional image on a display by computer graphics with a part of the object being displayed bright (e.g., a three-dimensional object is displayed as a two-dimensional image by a ray tracing method. Consequently, the printed image which actually has a thickness of 5 μm or so is sensed thicker by the observer.

Sensing a printed image thicker than the actual thickness due to the embossing phenomenon is called “embossing feeling” herein. The “embossing feeling” is a unique problem which arises when an image is printed by the ink jet method using UV ink.

Note that a printed image formed by ordinary prepressing (aniline printing, offset printing or the like) hardly has a thickness as compared with a printed image formed with using UV ink. Therefore, a printed image formed by ordinary prepressing does not show an “embossing phenomenon”, and does not thus raise the problem of “embossing feeling”. In addition, a printed image printed by permeating ink in a medium also hardly has a thickness. Likewise, a printed image printed by permeating ink in a medium does not show an “embossing phenomenon”, and does not thus raise the problem of “embossing feeling”. It is apparent from the above that the embossing phenomenon and embossing feeling uniquely occur when an image is printed by the ink jet method using UV ink.

### Outline of Embodiment

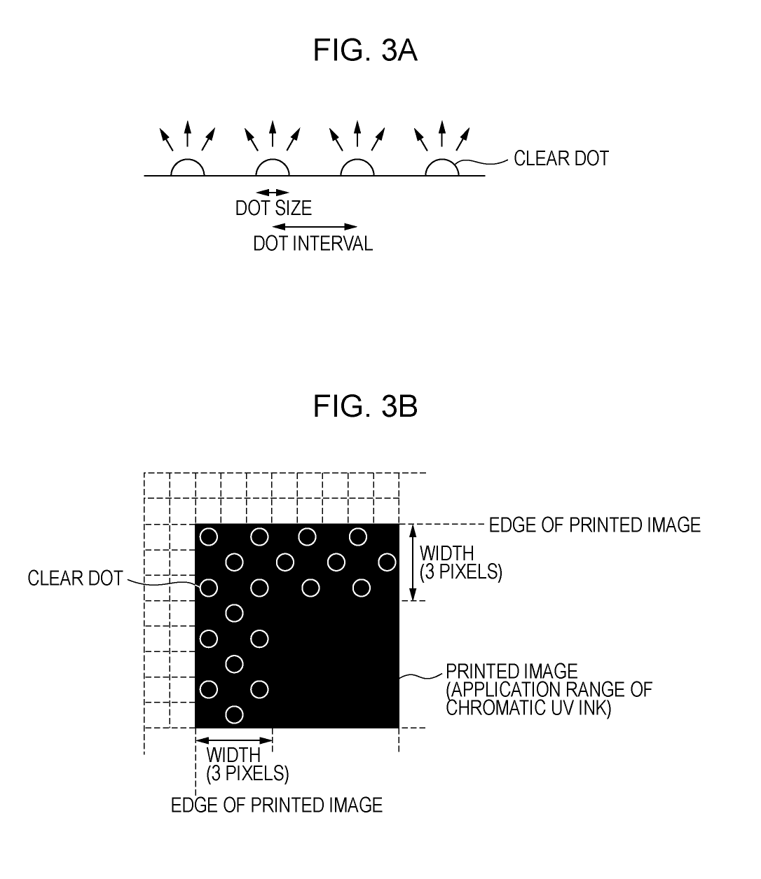

FIGS. 3A and 3B are explanatory diagrams showing the outline of an embodiment. FIG. 3A is an explanatory diagram showing how it appears when achromatic UV ink is applied with a reduced amount of ink per unit area. FIG. 3B is an explanatory diagram showing how it appears when clear dots are formed along an edge on a printed image.

As already mentioned above, dots formed with UV ink are embossed on the surface of the medium. When dots are formed by applying achromatic UV ink with a reduced amount of ink per unit area in such a way that the interval between the dots becomes wider than the dot size (hereinafter, dots of achromatic UV ink are called “clear dots”) as shown in FIG. 3A, irregularities can be formed on the surface of the medium. The irregularities scatter light incident to the printing surface, making the printing surface non-glossy, so that the printing surface is seen as a rough mat.

According to the embodiment, therefore, clear dots formed on a printed image (application range of chromatic UV ink) along the edge as shown in FIG. 3B. As a result, the periphery of the printed image becomes non-glossy to inhibit the printed image from being seen bright along the edge as shown in FIG. 2B, thus suppressing the embossing feeling.

According to the embodiment, clear dots are formed not in the entire range of a printed image (the entire application range of chromatic UV ink). The range of forming clear dots (application range of achromatic UV ink) is just a portion on the printed image along the edge thereof. This makes it possible to reduce the amount of achromatic UV ink consumed as compared to the case of forming clear dots in the entire range of the printed image. In addition, the glossiness of a printed image which is a filled image can be maintained.

Although the width of the formation range of clear dots is three pixels in FIG. 3B, the width is not limited to three pixels. The width of the formation range of clear dots is set to a value suitable for suppressing embossing feeling. For example, the width of the formation range of clear dots is set in such a way as to include the position A in FIG. 1B (thickest position near the edge of the printed image).

### Fundamental Configuration

First, the fundamental configuration of the printing apparatus will be described. Note that the “printing apparatus” according to the embodiment forms clear dots along the edge of a printed image while printing an image in chromatic UV ink. For example, an apparatus (system) including a printer 1 and a computer 110 having a printer driver installed therein, both of which will be described below, is equivalent to the printing apparatus. A controller 10 of the printer 1, and the computer 110 constitute a control unit for controlling the printing apparatus.

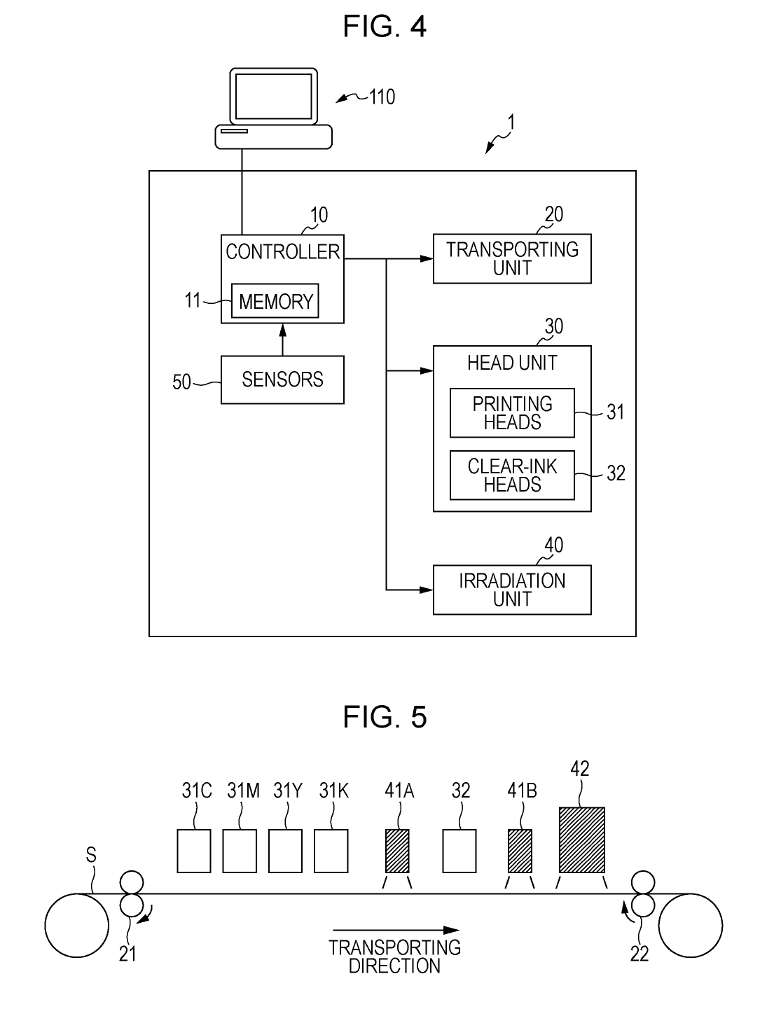

FIG. 4 is a block diagram of the general configuration of the printer 1. FIG. 5 is an explanatory diagram of the general configuration of the printer 1. The printer 1 according to the embodiment is what is called a line printer. However, the printer 1 may be a serial printer (printer with a head mounted on a carriage which is movable in the widthwise direction of a sheet), not a line printer.

The printer 1 includes the controller 10, a transporting unit 20, a head unit 30, an irradiation unit 40, and sensors 50. The printer 1 which receives print data from the computer 110 or the print control unit controls the individual units (transporting unit 20, head unit 30, irradiation unit 40, etc.) by means of the controller 10.

The controller 10 is a control unit that controls the printer 1. The controller 10 controls the individual units according to a program stored in a memory 11. Based on the print data received from the computer 110, the controller 10 controls the individual units, and prints an image on a medium S. The controller 10 receives various detection signals detected by the sensors 50.

The transporting unit 20 transports the medium S (such as a sheet or film) in a transporting direction. The transporting unit 20 has a transporting motor (not shown), upstream rollers 21 and downstream rollers 22. When the unillustrated transporting motor rotates, the upstream rollers 21 and the downstream rollers 22 roll to transport a roll of the medium S in the transporting direction.

The head unit 30 ejects a liquid (chromatic UV ink, achromatic UV ink or the like) onto the medium S. The head unit 30 has printing heads 31 and clear-ink heads 32. The printing heads 31 eject chromatic ink onto the medium S to form an image. The printing heads 31 include cyan heads 31C that eject clear ink, magenta heads 31M that eject magenta ink, yellow heads 31Y that eject yellow ink, and black heads 31K that eject black ink.

The clear-ink heads 32 eject achromatic ink (clear ink) onto the medium S. According to the embodiment, clear dots are formed along the edge of a printed image, and the clear-ink heads 32 eject clear ink for forming clear dots on the medium S. The clear-ink heads 32 are provided upstream of the printing heads 31 in the transporting direction.

Each group of heads (printing heads 31 and clear-ink heads 32) has a plurality of heads aligned in the widthwise direction of the sheet (direction perpendicular to the sheet face of FIG. 5), and each head has a plurality of nozzles aligned in the widthwise direction of the sheet. Accordingly, each group of heads can form dots by the width of the sheet at a time. When the printing heads 31 eject ink toward the medium S during transportation, a two-dimensional printed image is formed on the printing surface of the medium S. When the clear-ink heads 32 eject ink toward the medium S during transportation, clear dots can be formed on the printing surface of the medium S.

According to the embodiment, the individual nozzles of the printing heads 31 eject chromatic UV ink. UV ink has such a property as to be cured by the irradiation of UV light. The UV ink has a higher viscosity than permeable ink which permeates in a medium to print an image. Even if printing is done on an ordinary sheet, the UV ink is less absorbed than the permeable ink. Because the UV ink forms dots to be cured and fixed on a medium, the UV ink can print an image even on a non-ink-absorbent medium which does not have an ink absorbing layer. Although ink described in, for example, JP-A-2006-199924 can be used as UV ink, another type of UV ink may be used.

According to the embodiment, the individual nozzles of the clear-ink heads 32 eject achromatic UV ink. Achromatic UV ink also has such a property as to be cured by the irradiation of UV light.

The irradiation unit 40 irradiates UV light on the UV ink ejected on the medium S. The irradiation unit 40 has a first temporary-curing irradiation section 41A, a second temporary-curing irradiation section 41B, and an actual-curing irradiation section 42.

The first temporary-curing irradiation section 41A is provided downstream of a print region in the transporting direction (downstream of the printing heads 31 in the transporting direction). The first temporary-curing irradiation section 41A irradiates UV light intense enough to cure (temporarily cure) the surface of the chromatic UV ink applied to the medium S. As a result, the chromatic UV ink and achromatic UV ink to be applied later can be prevented from being bled. Although a single first temporary-curing irradiation section 41A is provided downstream of the printing heads 31 in the transporting direction according to the embodiment, a temporary-curing irradiation section may be provided downstream of each of four groups of heads of four colors in the transporting direction.

The second temporary-curing irradiation section 41B is provided downstream of the clear-ink heads 32 in the transporting direction. The second temporary-curing irradiation section 41B irradiates UV light intense enough to cure (temporarily cure) the surface of the achromatic UV ink (clear dots) applied to the medium S. The temporary curing of the clear dots can suppress the speed of widening the diameter of the clear dots.

For example, LEDs (Light Emitting Diodes) or the like are used as the first temporary-curing irradiation section 41A and the second temporary-curing irradiation section 41B.

The actual-curing irradiation section 42 is provided downstream of the second temporary-curing irradiation section 41B in the transporting direction. The actual-curing irradiation section 42 irradiates UV light intense enough to actually cure (completely fix) the UV ink on the medium S. For example, an UV lamp or the like is used as the actual-curing irradiation section 42.

In printing an image, the controller 10 causes the printing heads 31 to eject chromatic UV ink to apply the UV ink to the medium S while causing the transporting unit 20 to transport the medium S in the transporting direction, and causes the first temporary-curing irradiation section 41A to irradiate UV light to temporarily cure dots (color dots) formed in the chromatic UV ink. Then, the controller 10 causes the clear-ink heads 32 to eject achromatic UV ink (clear ink) to form clear dots along the edge of the printed image formed by the color dots while transporting the medium S, and causes the second temporary-curing irradiation section 41B to irradiate UV light to temporarily cure the clear dots. Thereafter, the controller 10 causes the actual-curing irradiation section 42 to irradiate UV light to completely cure the dots, and takes up the medium S with the printed image printed thereon at the downstream of the downstream rollers 22 in the transporting direction.

The computer 110, connected to the printer 1 in a communicatable manner, sends print data according to an image to be printed to the printer 1 to cause the printer 1 to print the image.

The printer driver is installed in the computer 110. The printer driver is a program to convert image data output from an application program to print data. This printer driver is recorded on a recording medium (computer readable recording medium) such as a CD-ROM. The printer driver may be downloaded into the computer 110 over the Internet.

### Application of Clear Ink

When a user of the printer 1 instructs to print an image drawn on the application program, the printer driver of the computer 110 is activated. The printer driver receives image data from the application program, converts the image data to print data of a format which can be interpreted by the printer 1, and outputs the print data to the printer 1. At the time of converting image data from the application program to print data, the printer driver performs a resolution converting process, a color converting process, a half-tone process, etc. The printer driver according to the embodiment also performs a clear image generating process to generate print data for ejecting clear ink.

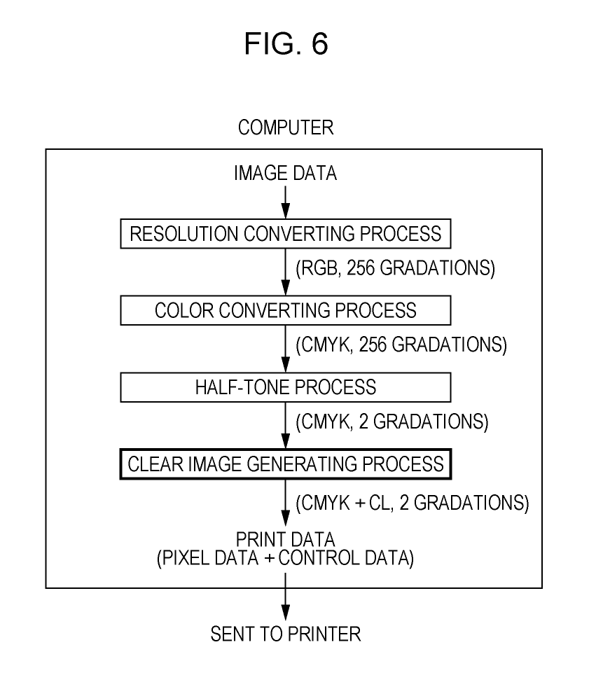

FIG. 6 is an explanatory diagram of the functions of the printer driver of the computer 110.

In the resolution converting process, image data (text data, image data, etc.) output from the application program is converted to have a resolution (printing resolution) for image data to be printed on the medium S. When the printing resolution is designed to be 720×720 dpi, for example, image data of a vector format received from the application program is converted to image data of a bitmap format with a resolution of 720×720 dpi. Each pixel data of the image data after the resolution converting process is RGB data of multiple gradations (e.g., 256 gradations) which is expressed by RGB color space.

In the color converting process, RGB data is converted CMYK data which is expressed by CMYK color space. CMYK data corresponds to the colors of chromatic ink of the printer 1. This color converting process is performed based on the a table (color converting look-up table LUT) having gradation values of RGB data associated with gradations of CMYK data. Pixel data after the color converting process is CMYK data of 256 gradations which is expressed by CMYK color space.

In the half-tone process, data of large gradations is converted to data whose number of gradations can be formed by the printer 1. For example, the half-tone process converts data indicating 256 gradations to 1-bit data indicating two gradations. In image data after the half-tone process, 1-bit pixel data corresponds to each pixel. 1-bit pixel data indicates presence/absence of a dot. Pixel data may be 2-bit data which indicates the size of a dot as well as presence/absence of the dot. In either case, pixel data after the half-tone process indicates dots to be formed on the medium S.

In the clear image generating process, as shown in FIG. 3B, print data for applying clear ink along the edge of a printed image is generated.

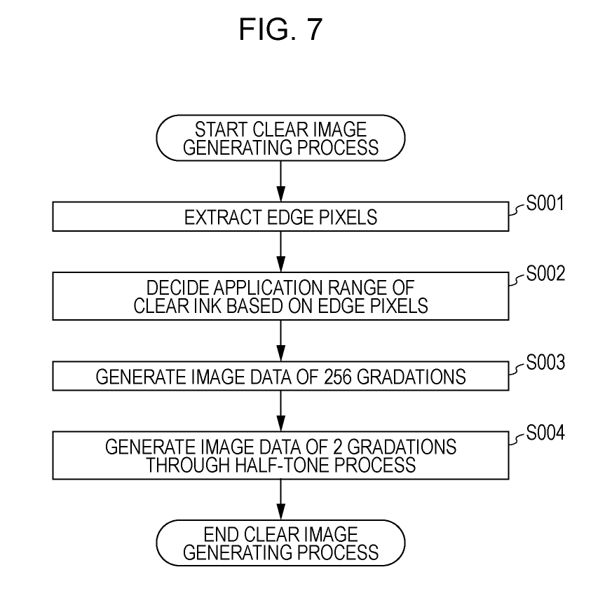

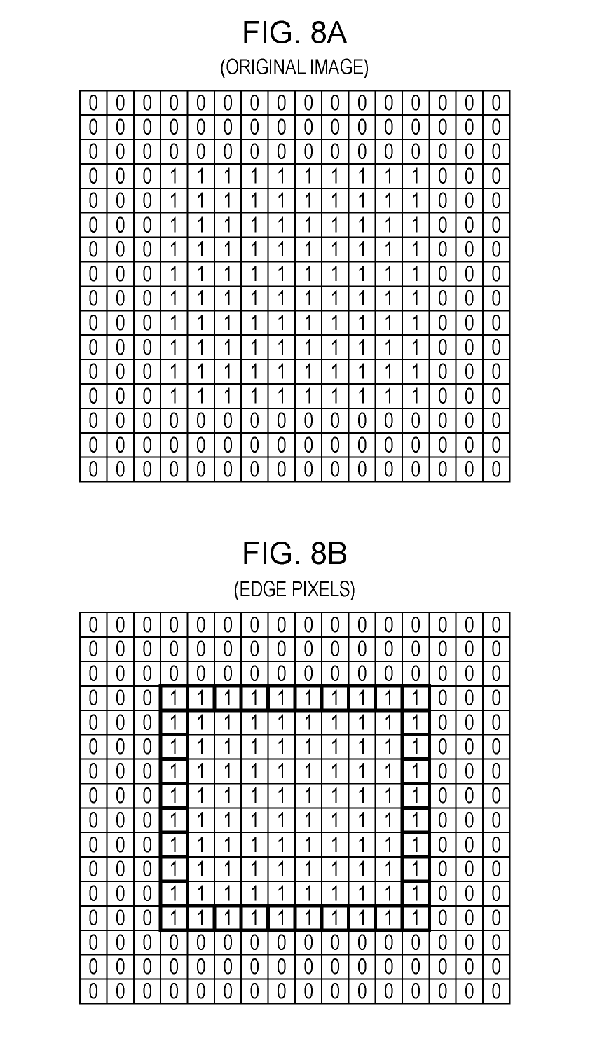

FIG. 7 is a flowchart of the clear image generating process in FIG. 6. FIG. 8A is an explanatory diagram of image data in black after the half-tone process in FIG. 6. To simplify the description, the following gives a description of only black image data.

It is assumed that 1-bit pixel data is associated with each pixel in the image data shown in FIG. 8A. Note that black UV ink is ejected based on the image data shown in FIG. 8A, the black UV ink is ejected on pixels with image data of “1” to form dots, and UV ink is not ejected on pixels with image data of “0” so that dots are not formed. It is assumed herein that the image data contains a filled image having 10×10 pixels.

The printer driver performs an edge extracting process on image data after the half-tone process (see FIG. 8A) to extract edge pixels located on the contour of the image (FIG. 7: S001). In this step, pixels indicated by a thick frame in FIG. 8B are extracted as edge pixels.

Next, the printer driver decides the application range of clear ink (FIG. 7: S002). In this step, the application range is decided with the width of the application range of clear ink being three pixels.

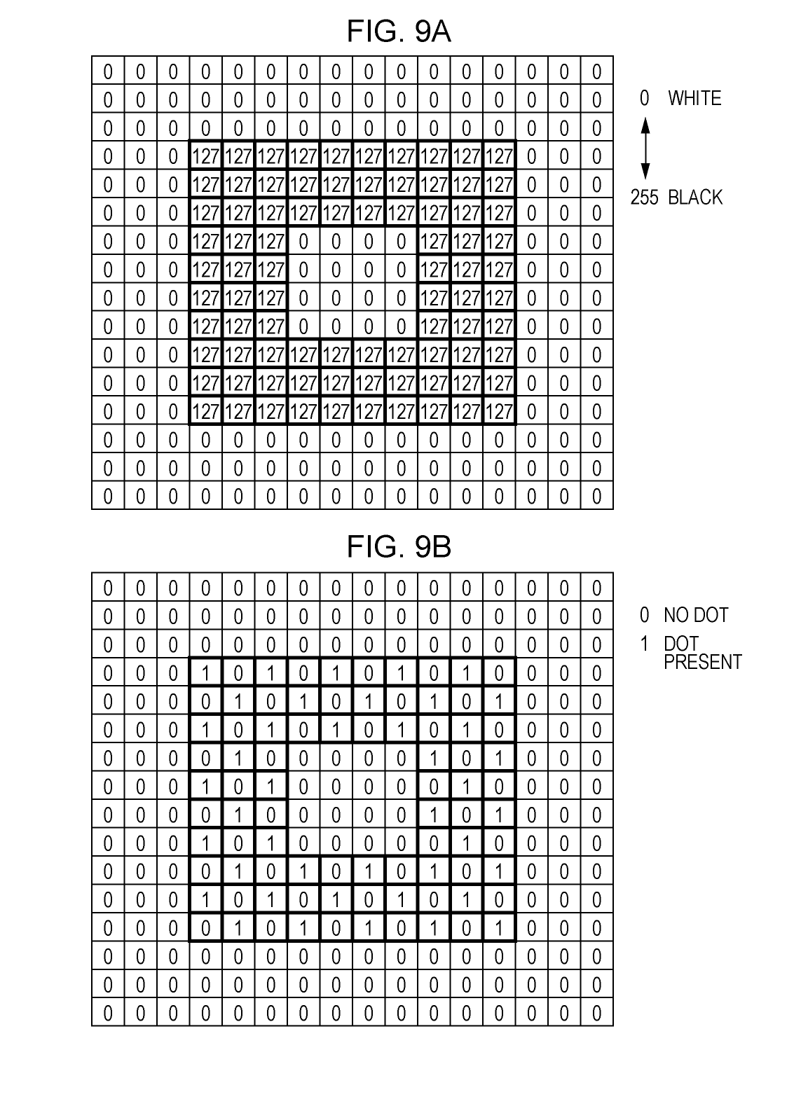

Next, the printer driver generates image data of 256 gradations for clear ink according to the decided application range of clear ink (FIG. 7: S003). In this step, pixels indicated by a thick frame in FIG. 9A become pixels located in the application range of clear ink. As illustrated, pixel data “127” indicating the gray scale value is associated with the pixels indicated by the thick frame, and pixel data “0” indicating white is associated with the other pixels. The gray scale values are set according to the amount of ink per unit area in the application range of clear ink. The smaller the amount of ink per unit area is, the smaller the gray scale values are set. In this manner, the printer driver generates image data of 256 gradations for clear ink for ejecting clear ink separately from image data for ejecting chromatic UV ink.

Next, the printer driver performs the half-tone process on image data of 256 gradations for clear ink (FIG. 9A) to generate image data of two gradations for clear ink. FIG. 9B is an explanatory diagram of image data for clear ink of two gradations. 1-bit pixel data corresponds to each pixel, and 1-bit pixel data indicates presence/absence of a clear dot.

The computer 110 adds control data to image data including 2-gradation pixel data to generate print data, and sends the print data to the printer 1 (see FIG. 6). Upon reception of the print data, the printer 1 controls the individual units according to the control data included in the print data, ejects UV ink from the individual nozzles of the printing heads 31 according to image data for ejection of UV ink (see FIG. 8A), and ejects clear ink from the individual nozzles of the clear-ink heads 32 according to image data for clear ink (see FIG. 9B), thereby printing an image on the medium S.

The printer 1 ejects chromatic UV ink from the printing heads 31 to apply the chromatic UV ink to the application range of 10×10 pixels while transporting the medium S, and irradiates UV light from the first temporary-curing irradiation section 41A to temporarily cure a printed image formed by the chromatic UV ink (color dots). Then, as shown in FIG. 3B, the printer 1 applies clear ink to the application range with a width of three pixels along the edge of the temporarily cured printed image, and irradiates UV light from the second temporary-curing irradiation section 41B to temporarily cure clear dots. Thereafter, the printer 1 irradiates UV light from the actual-curing irradiation section 42 to completely cure the dots (color dots and clear dots). As a result, the printed image formed by the UV ink is fixed on the medium S.

According to the embodiment, clear ink is applied on a printed image along the edge thereof, thereby making the periphery of the printed image non-glossy. This inhibits the printed image from being seen bright along the edge thereof as shown in FIG. 2B, thus suppressing embossing feeling.

According to the embodiment, the amount of ink per unit area in the application range of clear ink is set less than the amount of ink per unit area in the range of a printed image (application range chromatic UV ink). This is because chromatic UV ink is applied to the application range without clearances to form a filled image, whereas clear ink is applied with some clearances to form irregularities on the surface of the medium S. It is to be noted however that the amount of ink per unit area in the application range of clear ink can be arbitrarily set by adjusting the gray scale values of image data of 256 gradations for clear ink (see FIG. 9A).

According to the embodiment, the diameter of clear dots (the diameter of dots of achromatic UV ink) is set smaller than the interval of the clear dots (see FIG. 3A). This can permit irregularities to be efficiently formed on the surface in the application range of clear ink with a smaller amount of ink. Even if some adjoining clear dots are jointed together, however, irregularities can be formed on the surface if there are clearances provided in the application range of clear ink.

### Another Embodiment

Due to a mounting error of the printing heads and the clear-ink heads, the positional relation between the application range of a printed image and the application range of clear ink may be deviated. In addition, because of the transporting unit 20 transporting the medium S obliquely or zigzag, the positional relation between the application range of a printed image and the application range of clear ink may be deviated.

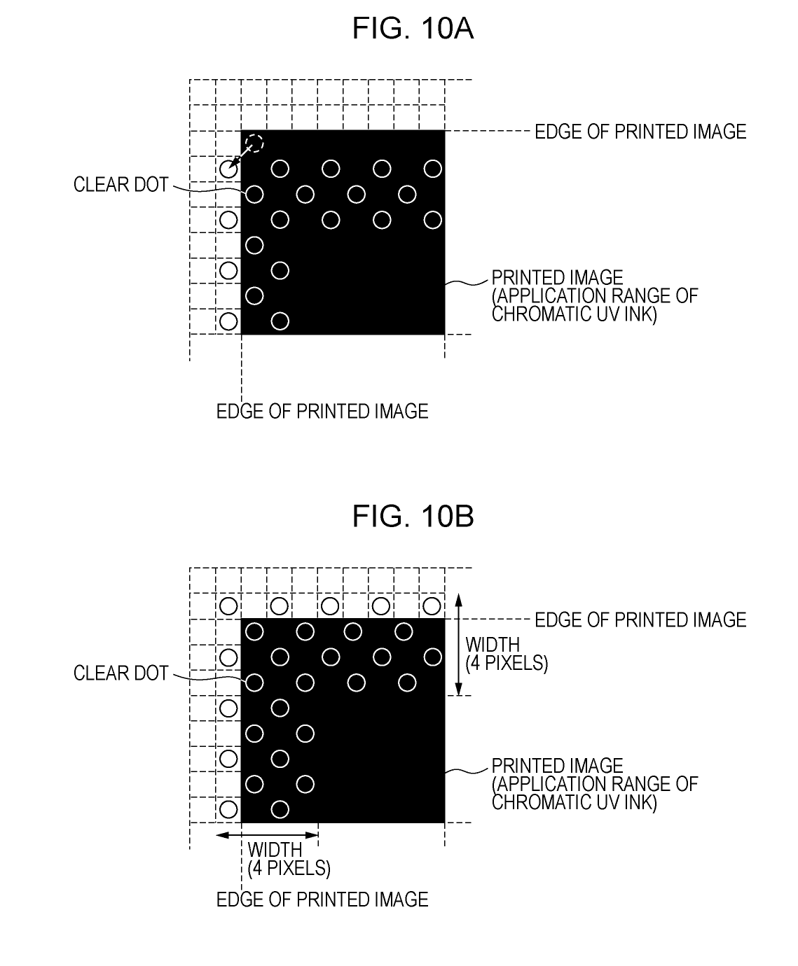

FIG. 10A is an explanatory diagram when the positional relation between the application range of a printed image and the application range image of clear ink is deviated. FIG. 10A shows clear dots are shifted by one pixel vertically and horizontally due to the influence of the mounting error of the heads although an attempt is made to apply clear ink as shown in FIG. 3B.

When the positional relation between the application range of a printed image and the application range image of clear ink is deviated in this manner, a region where clear dots are not formed is produced near the upper edge of the printed image in the FIG. 10A. As a result, a part of the printed image becomes glossy along the edge thereof in the region where clear dots are not formed as shown in FIG. 2B, which may bring about embossing feeling.

FIG. 10B is an explanatory diagram of another embodiment showing clear dots formed on a printed image along the edge thereof.

According to the embodiment, clear dots are also formed outside a printed image (outside the application range of chromatic UV ink). Application of clear ink on a printed image along the edge thereof as well as application of clear ink outside the printed image can suppress embossing feeling even if the positional relation between the application range of the printed image and the application range of clear ink is deviated.

### Other Embodiments

The foregoing embodiments have been given for ease of understanding the invention, and should not be construed to be restrictive. The invention may of course be modified and improved without departing the scope of the invention, and may include equivalents of such modifications and improvements.

### Filled Image

The foregoing filled image is an image having dots formed in all the pixels. However, the filled image is not restrictive, may be any image intended to have a predetermined region on a medium filled with ink, and may contain some pixels where dots are not formed.

### Line Printer

The printer 1 is what is called a line printer which has fixed heads to which a medium having rows of dots are formed thereon in the transporting direction is transported. However, the printer 1 is not limited to the line printer. For example, the printer 1 may be what is called a serial printer which has heads provided to be movable in the main scanning direction, and alternately repeats a dot forming operation of forming rows of dots in the main scanning direction while ejecting UV ink from the moving heads and a transporting operation of transporting the medium.

In case of such a serial printer, rows of dots can be formed at intervals narrower than the nozzle pitch. That is, the printing resolution can be set higher than the nozzle pitch. Accordingly, the resolution of the aforementioned image data may be higher than the nozzle pitch, not the same as the nozzle pitch.

### Processing of Computer 110

The computer 110 performs the resolution converting process, the color converting process, the half-tone process, the clear image generating process, etc. However, some of or all of the processes may be carried out by the printer 1. When the printer 1 performs the clear image generating process which is carried out by the computer 110, the printer 1 can alone form clear dots on a medium, so that the printer 1 alone is equivalent to the “printing apparatus”.

The entire disclosure of Japanese Patent Application No. 2011-094328, filed Apr. 20, 2011 is expressly incorporated by reference herein.

What is claimed is:

1. A printing apparatus comprising:
a chromatic ink ejecting nozzle that ejects a chromatic photocuring ink which is cured upon irradiation of light onto a medium;
an achromatic ink ejecting nozzle that ejects an achromatic photocuring ink which is cured upon irradiation of light onto the medium; and
an irradiation section that irradiates the light onto the chromatic photocuring ink impacted on the medium,
wherein at a time of applying the chromatic photocuring ink to print an image on the medium, the printing apparatus performs a process of ejecting the chromatic photocuring ink on the medium, a process of ejecting the achromatic photocuring ink on the medium from the achromatic ink ejecting nozzle in such a way as to apply the achromatic photocuring ink along an edge of an application range of the chromatic photocuring ink, and a process of irradiate the light from the irradiation section to cure the photocuring ink.

2. The printing apparatus according to claim 1, wherein an amount of ink per unit area in an application range of the achromatic photocuring ink is less than an amount of ink per unit area in the application range of the chromatic photocuring ink.

3. The printing apparatus according to claim 1, wherein a dot size of the achromatic photocuring ink is less than a dot interval of the achromatic photocuring ink.

4. The printing apparatus according to claim 1, wherein the achromatic photocuring ink is applied to outside the application range of the chromatic photocuring ink.

5. The printing apparatus according to claim 1, wherein the image is printed on a medium which does not have an ink absorbing layer.

6. A printing method using a chromatic ink ejecting nozzle that ejects a chromatic photocuring ink which is cured upon irradiation of light onto a medium, an achromatic ink ejecting nozzle that ejects an achromatic photocuring ink which is cured upon irradiation of light onto the medium, and an irradiation section that irradiates the light onto the chromatic photocuring ink impacted on the medium, the printing method comprising:
at a time of applying the chromatic photocuring ink to print an image on the medium,
a process of ejecting the chromatic photocuring ink on the medium;
a process of ejecting the achromatic photocuring ink on the medium from the achromatic ink ejecting nozzle in such a way as to apply the achromatic photocuring ink along an edge of an application range of the chromatic photocuring ink; and
a process of irradiate the light from the irradiation section to cure the photocuring ink.

7. A program allowing a printing apparatus including a chromatic ink ejecting nozzle that ejects a chromatic photocuring ink which is cured upon irradiation of light onto a medium, an achromatic ink ejecting nozzle that ejects an achromatic photocuring ink which is cured upon irradiation of light onto the medium, and an irradiation section that irradiates the light onto the chromatic photocuring ink impacted on the medium to perform:
at a time of applying the chromatic photocuring ink to print an image on the medium,
a process of ejecting the chromatic photocuring ink on the medium;
a process of ejecting the achromatic photocuring ink on the medium from the achromatic ink ejecting nozzle in such a way as to apply the achromatic photocuring ink along an edge of an application range of the chromatic photocuring ink; and
a process of irradiate the light from the irradiation section to cure the photocuring ink.
